(19) United States
(12) Patent Application Publication
(10) Pub. No.: US 2021/0268744 A1
(43) Pub. Date: Sep. 2, 2021

(54) PRINTERS WITH ORIENTABLE MICRO-MIRRORS

(71) Applicant: HEWLETT-PACKARD DEVELOPMENT COMPANY, L.P., Spring, TX (US)

(72) Inventors: Seongsik Chang, Palo Alto, CA (US); Chris Paul Schodin, San Diego, CA (US)

(73) Assignee: HEWLETT-PACKARD DEVELOPMENT COMPANY, L.P., Spring, TX (US)

(21) Appl. No.: 17/258,279

(22) PCT Filed: Oct. 24, 2018
(86) PCT No.: PCT/US2018/057326

§ 371 Date: Jan. 6, 2021

(51) Int. Cl. B29C 64/393; B33Y 30/00; B33Y 50/02; B29C 64/277; G05B 19/4099

(52) U.S. Cl. CPC B29C 64/393; B33Y 30/00; B33Y 50/02; G05B 2219/49023; G05B 19/4099; G05B 2219/49013; B29C 64/277

(57) ABSTRACT

Printers with orientable micro-mirrors are disclosed. An example printer includes a first micro-minor, a second micro-minor, a third micro-mirror, an energy source; and a controller. The controller is to, during a first time period, orient the first micro-mirror toward a first area of a powder bed, orient the second micro-minor toward the first area of the powder bed, orient the third micro-mirror toward a second area of the powder bed, and activate the energy source, wherein powder in the first area of the powder bed fuses to form a portion of an object in response to energy directed by the first micro-mirror toward the first area and in response to concurrent direction of energy by the second micro-minor toward the first area.

### BACKGROUND

Photonic fusion printers print objects via additive printing processes. Photonic fusion printers direct energy (e.g., light) output by an energy source (e.g., a lamp) to melt, fuse and solidify together particles of a powder bed to form objects having different shapes. Three-dimensional (3D) objects are formed by additive application of successive layers or volumes of a build material, such as a powder or powder-like material, to an existing solid portion, solid surface or solid previous layer.

### BRIEF DESCRIPTION OF THE DRAWINGS

FIG. 1 is a block diagram illustrating an example photonic fusion printer in accordance with teachings of this disclosure.

FIG. 2 illustrates a portion of the example micro-mirror array of FIG. 1 in more detail.

FIG. 3 is a table representing example assignments of micro-mirrors to fusing areas for different time periods.

FIG. 4 illustrates an example use of a micro-mirror array to print an object using more fusing areas than the number of micro-mirrors in the micro-mirror array.

FIG. 5 is a side view illustration of an example three by three (3×3) arrangement of micro-mirrors to fuse larger fusing areas.

FIG. 6 is an end view of an example array of multiple micro-mirror arrays.

FIG. 7 is a flowchart representative of example hardware logic or machine-readable instructions for implementing the example printer of FIGS. 1-6 to perform photonic fusion printing.

FIG. 8 illustrates an example processor platform structured to execute the example machine-readable instructions of FIG. 7 to implement the example printer of FIGS. 1-6.

When beneficial, the same reference numbers will be used throughout the drawing(s) and accompanying written description to refer to the same or like parts. The figures are not to scale. Instead, for clarity, dimensions may be enlarged in the drawings. Connecting lines or connectors shown in the various figures presented are intended to represent example functional relationships and/or physical or logical couplings between the various elements.

### DETAILED DESCRIPTION

Micro-mirror arrays (e.g., an array of micro-mirrors) have the potential to enable high-speed three-dimensional (3D) photonic fusion printing that has lower consumable costs, greater green strength (e.g., handling strength), fewer solidification cracks, etc. However, some micro-mirror arrays can withstand up to approximately fifty watts per square centimeter (50 W/cm²) of continuous energy exposure. Beyond this level, micro-mirrors can become damaged, e.g., begin melting. An example flash lamp used in photonic fusion provides approximately fifty Joules per square centimeter (50 J/cm²) per each layer. However, a peak intensity of approximately ten kilowatts per square centimeter (10 kW/cm²) at a bed of powder (a.k.a. powder bed) may be desired, which is well beyond the 50 W/cm² constant intensity (or 1 kW/cm² pulsed intensity for a certain pulse duty cycles and pulse width) tolerated by micro-mirrors. Thus, in some examples, the energy intensity for photonic fusion would damage some micro-mirrors.

It has been advantageously discovered that typically (e.g., on average) about ten percent (10%) or so of a powder bed (e.g., 10% of the fusing areas of the powder bed) will be fused per layer. The remaining ninety percent (90%) or so are not fused during that time period. In prior systems, there is a one-to-one (1:1) correspondence between micro-mirrors and fusing areas, and a micro-mirror is either reflecting energy towards its respective fusing area, or not (e.g., reflecting energy into an energy sink). Thus, in an example, roughly 90% of the micro-mirrors are unused during any given time period and their associated energy (e.g., light) is wasted. In some examples, the fusing areas to be fused are used to concurrently print multiple objects at the same time. For example, one-half of the fusing areas could be allocated to a first object, and the other half of the fusing areas could be allocated to a second object.

In stark contrast, example apparatus and methods disclosed herein advantageously use the previously unused 90% or so of the micro-mirrors to irradiate the 10% or so of the fusing areas that are being fused, thereby delivering additional energy to the 10% or so of the fusing areas that are being fused. Disclosed example micro-mirror arrays allow dynamic control of micro-mirror orientations. Each micro-mirror can be separately oriented (e.g., angled) to direct energy toward any fusing area at any given time. The micro-mirror orientations can be changed for any time period, layer, etc. More than one micro-mirror can be oriented to the same fusing area for the same or different time period. By dynamically controlling micro-mirror angles, one hundred percent (100%) of the micro-mirrors can be used to irradiate (e.g., direct light onto) the 10% of so of the powder bed being fused. Therefore, the intensity of the light at the fusing areas of the powder bed being fused can be increased by a factor of ten (1:10) compared to the intensity of light at the micro-mirrors. For example, using a 50 W/cm² continuous intensity (or 1 kW/cm² pulsed intensity) light source and ten micro-mirrors, a pulsed intensity of light at the powder bed of 10 kW/cm² can be achieved, without risk of micro-mirror damage. Alternatively, for a given intensity of light needed at the powder bed, the intensity of light that the micro-mirrors need to handle is reduced by a factor of ten (10:1). Thus, the benefits of flooded light photonic fusion can be obtained for micro-mirror based printers without risk of micro-mirror damage. Additionally, and/or alternatively, each layer can be fused with N exposures by fusing 10%/N of the fusing area at each exposure.

Reference will now be made in detail to non-limiting examples, some of which are illustrated in the accompanying drawings.

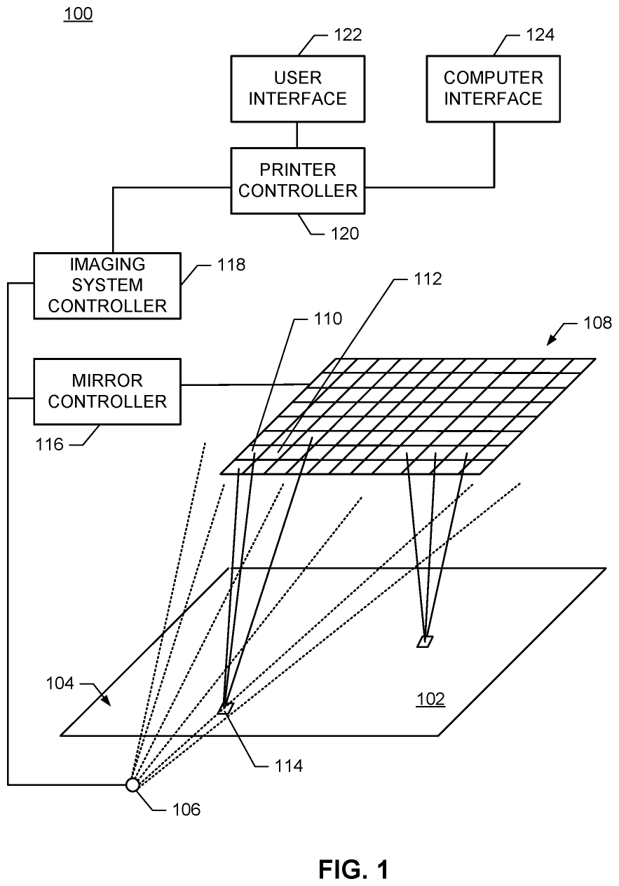

FIG. 1 is a block diagram illustrating an example photonic fusion printer 100 in accordance with teachings of this disclosure that may be used to print two-dimensional (2D) objects and/or 3D objects by the selective melting, fusing, neck-to-neck fusing, and/or solidification of powder 102 of a powder bed 104. Generally speaking, the example printer 100 of FIG. 1 may be an additive printer, a 3D fabricating system, a 3D printer, a 3D fabricator, or the like.

To direct energy (e.g., visible light, infrared radiation, heat, etc.) emitted by an energy source 106 onto the powder bed 104, the example printer 100 of FIG. 1 includes example micro-mirror array(s), one of which is designated at reference numeral 108. The example micro-mirror array 108 of FIG. 1 includes a plurality of micro-mirrors, two of which are designated at reference numeral 110 and 112. The example energy source 106 may be part of the photonic fusion printer 100, or may be separate from the photonic fusion printer 100. The energy source may emit continuous and/or pulsed energy.

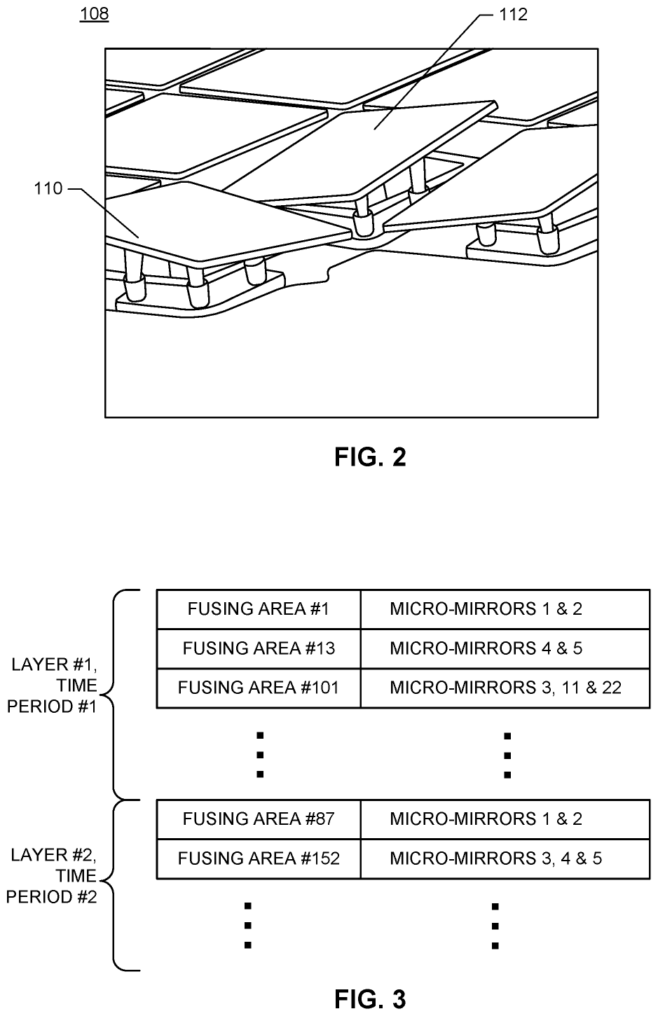

FIG. 2 illustrates an example portion of the bottom (in the orientation of FIG. 1) of the example micro-mirror array 108 of FIG. 1. The example micro-mirror array 108 includes a plurality of micro-mirrors (two of which are designated at reference numerals 110 and 112). The micro-mirrors 110, 112 are dynamically and separately controllable (orientable, angled, etc.) to different angles in one or two directions for different time periods. A micro-mirror's orientation can be changed over time, and for different layers of a printed object. Thereby, more than one micro-mirror 110, 112 can be controlled to direct energy emitted by the energy source 106 toward any fusing area 114 (see FIG. 1) at the same time (e.g., concurrently). When multiple micro-mirrors 110, 112 are concurrently oriented to the same fusing area 114 at the same time, then the energy directed by all of those micro-mirrors 110, 112 concurrently falls on the fusing area 114 at the same time, thereby increasing the amount of light impacting the fusing area 114.

In some examples, the micro-mirror array 108 is part of a microelectromechanical system (MEMS) device. In some examples, orientations, angles, positions, states, etc. of the micro-mirrors 110, 112 are controlled through application of voltage(s) between electrode(s) around the micro-mirrors 110, 112. In some examples, the micro-mirrors 110, 112 may have micron-scale sizes, e.g., between around ten microns and around twenty microns. In some examples, micro-mirrors 110, 112 are formed from any of a variety of materials, such as, for example. aluminum with a protective silicon dioxide layer on the aluminum to protect the aluminum from heat.

Returning to FIG. 1, the example energy source 106 of FIG. 1, when activated, outputs a pulse of flooded light. Example energy sources 106 include sources of visible light, infrared radiation, heat, etc. In prior solutions, light is reflected by a single micro-mirror 110, 112 onto a fusing area 114 (a voxel of the powder bed 104 or a voxel of an object being printed) at a time. The amount of light that can be reflected by the single micro-mirror 110, 112 without melting is insufficient to cause powder 102 in the fusing area 114 to at least partially melt and fuse. In stark contrast, in some disclosed examples including a dynamically controllable micro-mirror array more than one micro-mirror 110, 112 (e.g., two, three, ten, or more) are used to direct light to the same fusing area 114. In such examples, ten times (10×) more light is incident on the fusing area 114 than on the micro-mirrors 110, 112, and 10× more light than in prior solutions. Alternatively, the intensity of the light that needs to be emitted by the energy source 106 can be reduced by using multiple micro-mirrors 110, 112 to direct light to the same fusing area 114.

To control the example micro-mirror array 108, the example printer 100 of FIG. 1 includes an example micro-mirror controller 116. For each micro-mirror 110, 112, the example micro-mirror controller 116 determines the voltage(s) to use to orient the micro-mirror 110, 112 at an orientation, angle, position, etc. indicated by an example imaging system controller 118. The micro-mirror controller 116 uses circuit(s) to generate the voltage(s) and distribute them to the micro-mirrors 110, 112. In some examples, the mirror controller 116 and micro-mirror array 108 is implemented on the same device (e.g., the same MEMS device).

To determine to which fusing area 114 a micro-mirror 110, 112 is to be oriented, if any, the example printer 100 includes the example imaging system controller 118. The example imaging system controller 118 receives from an example printer controller 120 a list of fusing areas 114 to be fused during a time period, for a layer of an object being printed, etc. In some examples, the imaging system controller 118 evenly allocates micro-mirrors 110, 112 among the fusing areas 114 to be fused, and allocates the micro-mirrors 110, 112 closest to each fusing area 114 being fused to that fusing area 114. Other allocations may be used.

The imaging system controller 118 determines the angle(s) between each micro-mirror 110, 112 and the fusing area 114 to which the micro-mirror 110, 112 is assigned. Based on the angle, the imaging system controller 118 determines the needed orientation of the micro-mirror 110, 112. The controls (e.g., voltages) needed to set the micro-mirror 110, 112 to that orientation are determined and sent to the micro-mirror array 108.

FIG. 3 is a table representing an example micro-mirror to fusing area assignments. In the illustrated example of FIG. 3, layer #1 is printed during a first time period #1, and layer #2 is printed during a second time period #2. To print layer #1, powder in fusing areas 1, 13, 101 are to be fused. To fuse area 1, micro-mirrors 1 and 2 are oriented toward fusing area 1. While two micro-mirrors 1 and 2 are listed in FIG. 3 as being directed to fusing area 1, other numbers of micro-mirrors (e.g., ten) could be directed to fusing area 1. To fuse area 13, two micro-mirrors 4 and 5 (or other numbers of micro-mirrors) are oriented toward fusing area 13. To fuse area 101, micro-mirrors 3, 11 and 22 (or other numbers or micro-mirrors) are oriented toward fusing area 101.

In the illustrated example of FIG. 3, layer #2 is printed during a second time period #2. As shown, micro-mirrors can fuse different fusing areas at different times. For example, micro-mirrors 1 and 2 fused fusing area #1 for layer #1 during the first time period #1, and fused fusing area #87 for layer #2 during the second time period #2. Micro-mirrors may be combined with different micro-mirror(s) at different times or for different layers. For example, for layer #1 micro-mirrors 4 and 5 fused fusing area #13, while in layer #2 micro-mirrors 4 and 5 are combined with micro-mirror 3 to fuse fusing area #152. Other variations in the assignments of micro-mirrors to fusing areas may be used.

Returning to FIG. 1, to control the example printer 100, the example printer 100 of FIG. 1 includes the example printer controller 120. In addition to managing the example imaging system controller 118, the example printer controller 120 provides an example user interface 122, and an example computer interface 124. The example user interface 122 of FIG. 1 provides an interface at and/or on the printer 100 for configuration, control, etc. of the printer 100. For example, a person can use the user interface 122 to configure a network interface, cancel a print job, etc. The computer interface 124 provides an interface for a computer via a network (wired, wireless), a dedicated interface (e.g., USB), etc. to submit a print job. In some examples, a print job includes a sequence of fusing areas 114 to fuse on a sequence of layers of an object to be printed, etc. In some examples, a computer submits a print job in a generic format, which is translated by the imaging system controller 118 into a list of fusing areas 114 to be fused for each layer of the object to be printed.

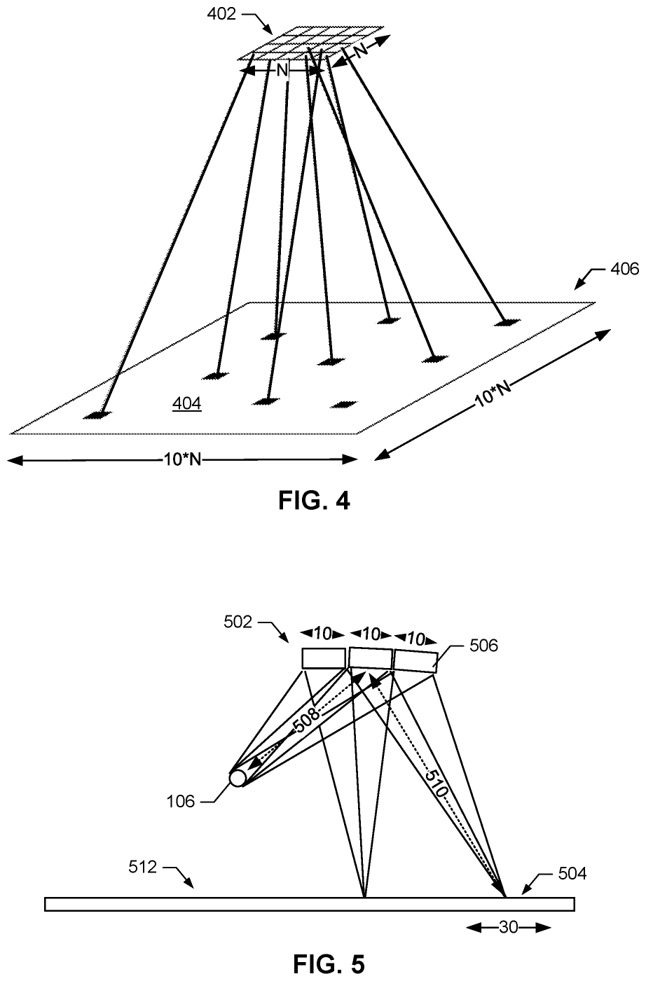

Dynamically controllable micro-mirror arrays can be used to provide alternative and/or additional advantages for photonic fusion printers, such as the example printer 100 of FIG. 1. For example, as shown in FIG. 4, a micro-mirror array 402 having an array of N micro-mirrors by N micro-mirrors can be used to fuse powder 404 in a powder bed 406 having 10*N fusing areas by 10*N fusing areas, assuming at most 10% of the fusing areas are fused during a given period of time. In such an example, an increase in light intensity at the powder bed 406 is not realized. Other ratios are possible. For example, an N×N micro-mirror array can be used to fuse 2*N×2*N fusing areas, while also providing a 5× increase in light intensity at the powder bed 406 compared to the micro-mirrors.

Turning to the side view of FIG. 5, a dynamically controllable example micro-mirror array 502 that may be used with the example printer 100 to fuse a fusing area 504 (e.g., voxel) having a size (e.g., 30 micrometers (um)×30 um) that is larger than a size (e.g., 10 um×10 um) of micro-mirrors 506 of the micro-meter array 502. A distance 508 between the energy source 106 and the micro-mirror array 502 and a distance 510 between the micro-mirror array 502 and a powder bed 512 can be adjusted so the 10 um×10 um micro-mirrors 506 project light onto substantially all of the 30 um×30 um fusing area 504. To prevent a decrease in light intensity at the powder bed 512, nine adjacent micro-mirrors in a 3×3 arrangement (three of which are seen in the side view of FIG. 5) can be dynamically controlled so all nine micro-mirrors 506 direct energy at the same 30 um×30 um fusing area 504. Thereby, fusing area size can be increases without a loss in light intensity. In other examples, arrays with other numbers of mirrors may be used.

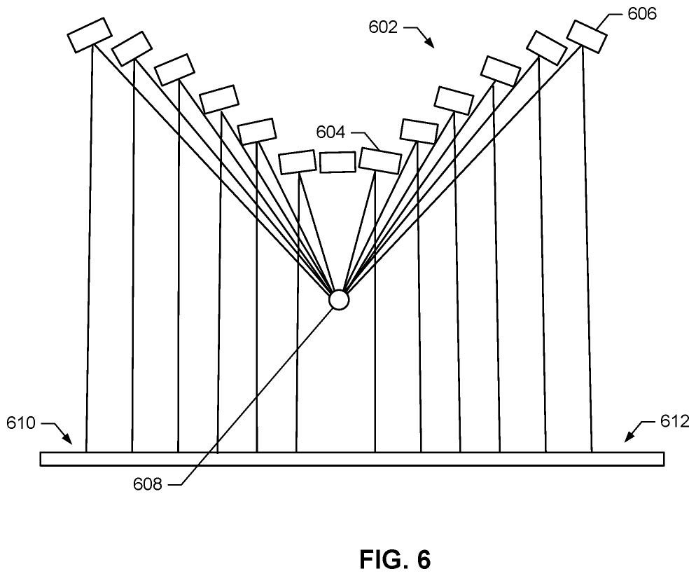

FIG. 6 is an end view of an example array 602 of multiple micro-mirror arrays (two of which are designated at reference numerals 604 and 606) that may be used with the example printer 100. In the illustrated example of FIG. 6, an energy (e.g., light) source 608 does not include a collimating reflector. Instead, light emitted from the light source 608 emanates in all directions, as shown in FIG. 6. Each of the micro-mirror arrays 604, 606 covers a particular portion 610 of a powder bed 612. In the illustrate example, the light source 608 to micro-mirror array 604, 606 distance is selected to be half the micro-mirror array 604, 606 to powder bed distance, thereby the resolution at the powder bed 612 is constant across the powder bed 612. Other distance ratios may be selected. Example micro-mirror sizes are 5 um to 13 um on a side, and example selective laser melting (SLM) powder sizes of 5 um to 40 um. Example resolutions at the powder bed 612 are 30 um to 40 um. Corresponding example magnifications include 0.4× for a 13 um micro-mirror size and 5 um powder size, 8× for a 5 um micro-mirror size and 40 um powder size, etc. As disclosed above, multiple micro-mirrors 604, 606 of a micro-mirror array 602 can direct light onto the same fusing area to increase light intensity at the powder bed 612 while reducing light intensity at the micro-mirror arrays 604, 606.

While an example manner of implementing the printer 100 is illustrated in FIGS. 1-6, element(s), process(es) and/or device(s) illustrated in FIGS. 1-6 may be combined, divided, re-arranged, omitted, eliminated and/or implemented in any other way. Further, the example micro-mirror arrays 108, 402, 502, 604 and 606, the example mirror controller 116, the example imaging system controller 118, the example printer controller 120, the example user interface 122, the example computer interface 124, and/or, more generally, the example printer 100 of FIGS. 1-6 may be implemented by hardware and/or machine readable instructions including software and/or firmware and/or any combination of hardware, software and/or firmware. Thus, for example, any of the example micro-mirror arrays 108, 402, 502, 604 and 606, the example mirror controller 116, the example imaging system controller 118, the example printer controller 120, the example user interface 122, the example computer interface 124, and/or, more generally, the example printer 100 of FIGS. 1-6 could be implemented by analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware (e.g., machine readable instructions) implementation, at least one of the example mirror controller 116, the example imaging system controller 118, the example printer controller 120, the example user interface 122, the example computer interface 124, and/or the example printer 100 of FIGS. 1-6 is/are hereby expressly defined to include a non-transitory computer-readable storage device or storage disk such as a memory, a digital versatile disk (DVD), a compact disc (CD), a Blu-ray disk, etc. including the software and/or firmware. Further still, the example printer 100 of FIGS. 1-6 may include element(s), process(es) and/or device(s) in addition to, or instead of, those illustrated in FIGS. 1-6, and/or may include more than one of any or all of the illustrated elements, processes and devices. As used herein, the phrase “in communication,” including variations thereof, encompasses direct communication and/or indirect communication through intermediary component(s), and does not require direct physical (e.g., wired) communication and/or constant communication, but rather additionally includes selective communication at periodic intervals, scheduled intervals, aperiodic intervals, and/or one-time events.

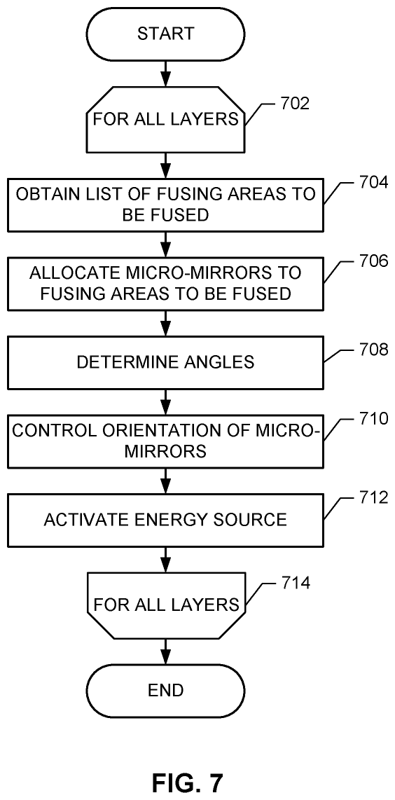

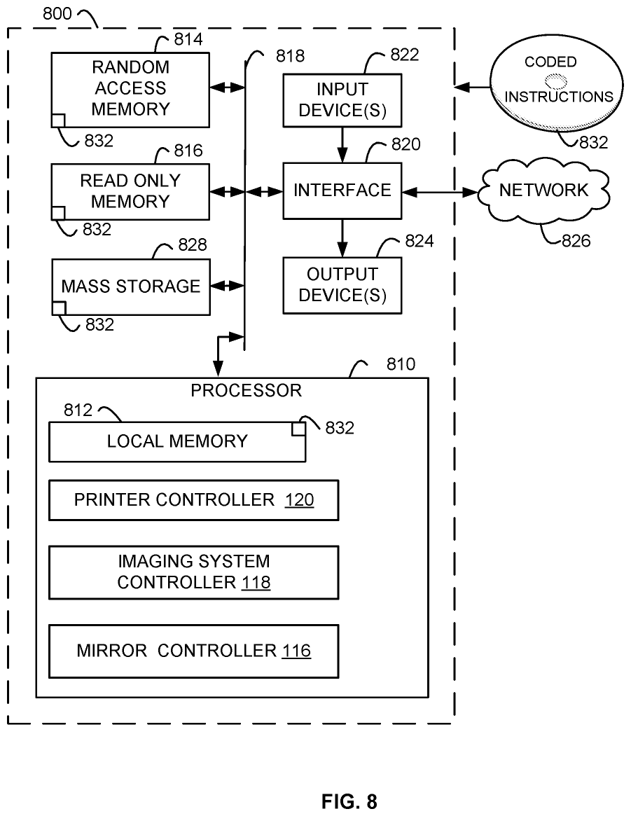

A flowchart representative of example hardware logic, machine-readable instructions, hardware implemented state machines, and/or any combination thereof for implementing the printer 100 of FIGS. 1-6 is shown in FIG. 7. The machine-readable instructions may be an executable program or portion of an executable program for execution by a computer processor such as the processor 810 shown in the example processor platform 800 discussed below in connection with FIG. 8. The program may be embodied in software stored on a non-transitory computer-readable storage medium such as a compact disc read-only memory (CD-ROM), a floppy disk, a hard drive, a DVD, a Blu-ray disk, or a memory associated with the processor 810, but the entire program and/or parts thereof could alternatively be executed by a device other than the processor 810 and/or embodied in firmware or dedicated hardware. Further, although the example program is described with reference to the flowchart illustrated in FIG. 7, many other methods of implementing the example printer 100 may alternatively be used. For example, the order of execution of the blocks may be changed, and/or some of the blocks described may be changed, eliminated, or combined. Additionally, and/or alternatively, any or all of the blocks may be implemented by hardware circuit(s) (e.g., discrete and/or integrated analog and/or digital circuitry, an FPGA, an ASIC, a comparator, an operational-amplifier (op-amp), a logic circuit, etc.) structured to perform the corresponding operation without executing software or firmware (e.g., machine readable instructions).

As mentioned above, the example processes of FIG.7 may be implemented using executable instructions (e.g., computer and/or machine-readable instructions) stored on a non-transitory computer and/or machine-readable medium such as a hard disk drive, a flash memory, a read-only memory, a CD-ROM, a DVD, a cache, a random-access memory and/or any other storage device or storage disk in which information is stored for any duration (e.g., for extended time periods, permanently, for brief instances, for temporarily buffering, and/or for caching of the information). As used herein, the term non-transitory computer-readable medium is expressly defined to include any type of computer-readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

The program of FIG. 7 begins at block 702 where, for all layers (block 702), imaging system controller 118 obtains a list of the fusing areas 114 to be fused for a layer of an object to be printed (block 704). The imaging system controller 118 allocates micro-mirrors 110, 112 to the fusing areas 114 to be printed (block 706). For example, micro-mirrors 110, 112 can be equally distributed to the fusing areas 114, distributed so that a maximum number are allocated to a fusing area 114, distributed so that micro-mirrors 110, 112 of a micro-mirror array 108 associated with the portion of the powder bed 104 including a fusing area 114 to be fused can be allocated to that fusing area 114, distribute a group of micro-mirrors 110, 112 associated with a fusing area larger than a micro-mirror, distribute micro-mirrors 110, 112 to a powder bed 104 having more fusing areas 114 than a micro-mirror array 108 has mirrors, any combinations thereof, etc.

The imaging system controller 118 determines the angles to be controlled for the micro-mirrors 110, 112 based on the allocations (block 708), and the mirror controller 116 correspondingly controls the orientation of the micro-mirrors 110, 112 (block 710).

The imaging system controller 118 activates the energy source 106 (block 712), and the energy is directed to the micro-mirrors 110, 112 and reflected to the desired fusing area 114 on the powder bed 104 to print the 3D object. Control returns to block 704 to print the next layer. When all layers have been printed (block 714), control exits from the example program of FIG. 7.

FIG. 8 is a block diagram of an example processor platform 800 structured to execute the instructions of FIG. 7 to implement the printer 100 of FIGS. 1-8. The processor platform 800 can be, for example, a server, a personal computer, a workstation, a self-learning machine (e.g., a neural network), a mobile device (e.g., a cell phone, a smart phone, a tablet such as an IPAD™), a personal digital assistant (FDA), an Internet appliance, a DVD player, a CD player, a digital video recorder, a Blu-ray player, a personal video recorder, or any other type of computing device.

The processor platform 800 of the illustrated example includes a processor 810. The processor 810 of the illustrated example is hardware. For example, the processor 810 can be implemented by integrated circuit(s), logic circuit(s), microprocessor(s), GPU(s), DSP(s), or controller(s) from any desired family or manufacturer. The hardware processor may be a semiconductor based (e.g., silicon based) device. In this example, the processor 810 implements the example mirror controller 116, the example imaging system controller 118 and the example printer controller 120.

The processor 810 of the illustrated example includes a local memory 812 (e.g., a cache). The processor 810 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), a Bluetooth® interface, a near field communication (NFC) interface, and/or a PCI express interface.

In the illustrated example, input device(s) 822 are connected to the interface circuit 820. The input device(s) 822 permit(s) a user to enter data and/or commands into the processor 810. The input device(s) can be implemented by, for example, an audio sensor, a microphone, a camera (still or video), a keyboard, a button, a mouse, a touchscreen, a track-pad, a trackball, isopoint and/or a voice recognition system.

Output device(s) 824 are also connected to the interface circuit 820 of the illustrated example. The output devices 824 can be implemented, for example, by the micro-mirror arrays 108, 420, 502, 604, 606, display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 820 of the illustrated example, thus, typically includes a graphics driver card, a graphics driver chip and/or a graphics driver processor.

The interface circuit 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

The processor platform 800 of the illustrated example also includes mass storage device(s) 828 for storing machine readable instructions such as software and/or data. Examples of such mass storage devices 828 include floppy disk drives, hard drive disks, CD drives, Blu-ray disk drives, redundant array of independent disks (RAID) systems, and DVD drives.

Coded instructions 832 including the coded instructions of FIG. 7 may be stored in the mass storage device 828, in the volatile memory 814, in the non-volatile memory 816, and/or on a removable non-transitory computer-readable storage medium such as a CD-ROM or a DVD.

Example methods, apparatus and articles of manufacture have been disclosed that improve the performance of printers, such as photonic fusion printers. The disclosed example methods, apparatus and articles of manufacture enhance the operations of a printer by improving the light handling of the printer. That is, through the use of these processes and structures, printers can operate more efficiently by providing more light to fuse powder without requiring a light source with higher light intensity, or risking exposure of printer components to high light intensities. The disclosed methods, apparatus and articles of manufacture are accordingly directed to advancements in the functioning of a printer.

Example methods, apparatus, and articles of manufacture to improve the light usage efficiency of photonic fusion printers are disclosed herein. Further examples and combinations thereof include at least the following.

An example printer includes a first micro-mirror, a second micro-mirror, a third micro-mirror, an energy source; and a controller. The controller is to, during a first time period, orient the first micro-mirror toward a first area of a powder bed, orient the second micro-mirror toward the first area of the powder bed, orient the third micro-mirror toward a second area of the powder bed, and activate the energy source, wherein powder in the first area of the powder bed fuses to form a portion of an object in response to energy directed by the first micro-mirror toward the first area and in response to concurrent direction of energy by the second micro-mirror toward the first area.

In some examples, the controller is to determine an angle between the first micro-mirror and the first area, and control an orientation of the first micro-mirror based on the angle.

In some examples, powder in the second area of the powder bed fuses to form another portion of at least one of the object or another object in response to concurrent direction of energy by the third micro-mirror toward the second area.

In some examples, the controller is to, during a second time period, orient the first micro-mirror toward a third area of the powder bed, orient the second micro-mirror toward the third area of the powder bed, and activate the energy source, wherein powder in the third area of the powder bed fuses to form another portion of the object in response to energy directed by the first micro-mirror toward the third area and in response to concurrent direction of energy by the second micro-mirror toward the third area.

In some examples, the controller is to, during a second time period, orient the first micro-mirror toward a third area of the powder bed, orient the third micro-mirror toward the third area of the powder bed, and activate the energy source, wherein powder in the third area of the powder bed fuses to form another portion of the object in response to energy directed by the first micro-mirror toward the third area and in response to concurrent direction of energy by the third micro-mirror toward the third area.

Some examples include a micro-mirror array including the first micro-mirror, the second micro-mirror, and the third micro-mirror.

In some examples, the energy source includes at least one of a source of pulsed visible light, a source of pulse infrared energy, a source of pulsed heat, a source of continuous visible light, a source of continuous infrared energy, or a source of continuous heat.

An example printer includes an energy source, an array of micro-mirrors, and a controller to control first micro-mirrors of the array of micro-mirrors to concurrently direct energy from the energy source toward a first fusing area in a powder bed to add first material to a solid portion of an item.

In some examples, the controller is to control second micro-mirrors of the array of micro-mirrors to concurrently direct energy from the energy source toward a second fusing area in the powder bed to add second material to the solid portion of the item.

In some examples, the first micro-mirrors include the second micro-mirrors, and the second fusing area is different from the first fusing area.

In some examples, the number of micro-mirrors in the array of micro-mirrors is less than a number of fusing areas in the powder bed.

In some examples, the controller is to, determine angles between the first micro-mirrors and the first fusing area, and control orientations of the first micro-mirrors based on respective ones of the angles.

In some examples, at least one of a first distance from the energy source to the array of micro-mirrors, or a second distance from the array of micro-mirrors to the powder bed is selected to control a resolution of fusing areas in the powder bed.

An example printer includes a light source to emit uncollimated light, a first array of micro-mirrors positioned to direct the uncollimated light toward a first portion of a powder bed, wherein at least one of a first distance from the light source to the first array of micro-mirrors, or a second distance from the first array of micro-mirrors to the powder bed is selected to control a first resolution of fusing areas in the first portion of the powder bed, and a second array of micro-mirrors positioned to direct the uncollimated light toward a second portion of the powder bed, wherein at least one of a third distance from the light source to the second array of micro-mirrors, or a fourth distance from the second array of micro-mirrors to the powder bed is selected to control a second resolution of fusing areas in the second portion of the powder bed.

In some examples, the second distance is selected to be different from first distance, and the second resolution is controlled to be the first resolution.

Any references, including publications, patent applications, and patents cited herein are hereby incorporated in their entirety by reference to the same extent as if each reference were individually and specifically indicated to be incorporated by reference and were set forth in its entirety herein.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A printer, the printer comprising:
a first micro-mirror;
a second micro-mirror;
a third micro-mirror;
an energy source; and
a controller to, during a first time period:
orient the first micro-mirror toward a first area of a powder bed,
orient the second micro-mirror toward the first area of the powder bed,
orient the third micro-mirror toward a second area of the powder bed, and
activate the energy source, wherein powder in the first area of the powder bed fuses to form a portion of an object in response to energy directed by the first micro-mirror toward the first area and in response to concurrent direction of energy by the second micro-mirror toward the first area.

2. The printer of claim 1, wherein the controller is to:
determine an angle between the first micro-mirror and the first area; and
control an orientation of the first micro-mirror based on the angle.

3. The printer of claim 1, wherein powder in the second area of the powder bed fuses to form another portion of at least one of the object or another object in response to concurrent direction of energy by the third micro-mirror toward the second area.

4. The printer of claim 1, wherein the controller is to, during a second time period:
orient the first micro-mirror toward a third area of the powder bed,
orient the second micro-mirror toward the third area of the powder bed, and
activate the energy source, wherein powder in the third area of the powder bed fuses to form another portion of the object in response to energy directed by the first micro-mirror toward the third area and in response to concurrent direction of energy by the second micro-mirror toward the third area.

5. The printer of claim 1, wherein the controller is to, during a second time period:
orient the first micro-mirror toward a third area of the powder bed,
orient the third micro-mirror toward the third area of the powder bed, and
activate the energy source, wherein powder in the third area of the powder bed fuses to form another portion of the object in response to energy directed by the first micro-mirror toward the third area and in response to concurrent direction of energy by the third micro-mirror toward the third area.

6. The printer of claim 1, further including a micro-mirror array including the first micro-mirror, the second micro-mirror, and the third micro-mirror.

7. The printer of claim 1, wherein the energy source includes at least one of a source of pulsed visible light, a source of pulse infrared energy, a source of pulsed heat, a source of continuous visible light, a source of continuous infrared energy, or a source of continuous heat.

8. A printer, comprising:
an energy source;
an array of micro-mirrors; and
a controller to control first micro-mirrors of the array of micro-mirrors to concurrently direct energy from the energy source toward a first fusing area in a powder bed to add first material to a solid portion of an item.

9. The printer of claim 8, wherein the controller is to control second micro-mirrors of the array of micro-mirrors to concurrently direct energy from the energy source toward a second fusing area in the powder bed to add second material to the solid portion of the item.

10. The printer of claim 9, wherein the first micro-mirrors include the second micro-mirrors, and the second fusing area is different from the first fusing area.

11. The printer of claim 8, wherein the number of micro-mirrors in the array of micro-mirrors is less than a number of fusing areas in the powder bed.

12. The printer of claim 8, wherein the controller is to:
determine angles between the first micro-mirrors and the first fusing area; and
control orientations of the first micro-mirrors based on respective ones of the angles.

13. The printer of claim 8, wherein at least one of a first distance from the energy source to the array of micro-mirrors, or a second distance from the array of micro-mirrors to the powder bed is selected to control a resolution of fusing areas in the powder bed.

14. A printer, comprising:
a light source to emit uncollimated light;
a first array of micro-mirrors positioned to direct the uncollimated light toward a first portion of a powder bed, wherein at least one of a first distance from the light source to the first array of micro-mirrors, or a second distance from the first array of micro-mirrors to the powder bed is selected to control a first resolution of fusing areas in the first portion of the powder bed; and
a second array of micro-mirrors positioned to direct the uncollimated light toward a second portion of the powder bed, wherein at least one of a third distance from the light source to the second array of micro-mirrors, or a fourth distance from the second array of micro-mirrors to the powder bed is selected to control a second resolution of fusing areas in the second portion of the powder bed.

15. The printer of claim 14, wherein the second distance is selected to be different from the first distance, and the second resolution is controlled to be the first resolution.
